(19) United States
(12) Patent Application Publication
(10) Pub. No.: US 2013/0262562 A1
(43) Pub. Date: Oct. 3, 2013

(54) DATA COMMUNICATION MANAGING SYSTEM AND METHOD THEREOF

(71) Applicants: Chien-Liang CHEN, Taipei (TW); Huang-Chih Chang, Taipei (TW)

(72) Inventors: Chien-Liang CHEN, Taipei (TW); Huang-Chih Chang, Taipei (TW)

(73) Assignee: Global Vision System Co., Ltd.

(21) Appl. No.: 13/493,573

(22) Filed: Jun. 11, 2012

(30) Foreign Application Priority Data
Mar. 28, 2012 (TW) 101110769

(51) Int. Cl. G06F 15/16

(52) U.S. Cl. 709/203

(57) ABSTRACT

The present invention provides a data communication managing system. The system includes a first network segment client, a second network segment client, and a center unit. The center unit includes a manage unit and transmit data with the first network segment client and the second network segment client, respectively. The manage unit includes a transmission management part which is used to disallow the data transmission between the first network segment client and the second network segment client.

### CROSS-REFERENCE TO RELATED APPLICATIONS

This Non-provisional application claims priority under 35 U.S.C. §119(a) on Patent Application No(s). 101110769 filed in Taiwan, Republic of China, Mar. 28, 2012, the entire contents of which are hereby incorporated by reference.

### FIELD OF THE INVENTION

This invention relates to a data communication managing system, and in particular, to a data communication managing system for efficiently decreasing the transmission amount in network backbone.

### BACKGROUND OF THE INVENTION

Peer-to-peer (P2P) is a kind of new network technology. Instead of using the bandwidth from a few number of servers, this technique used the bandwidth from clients. This technique was widely used in data sharing and was also used in real-time media transmission such as the voice over IP (VoIP).

A pure P2P method doesn't have the concept of server or client, only equal peer nodes, while act as the server and client for the other peer nodes on network. This network design model is different from the client-server model, which is usually communicating from only one central server.

FIG. 1 shows the schematic of conventional technology of P2P system. A P2P system 1 includes a central server 10, which is used to connect the clients. When the clients make requests, the central server 10 is responsible to release some related information corresponding to the requests. Whoever, since the central server 10 doesn't have the data corresponding to the requests, the central server 10 will only provide some related peer nodes for the data downloading.

Because the P2P technique will occupy a lot of network bandwidth, most of the internet service providers (ISP) will set a limit of the data downloading speed (usually lower than 521 Kb/s), limit the number of TCP connections, or block the P2P protocols. The transmission efficiency is limited.

### SUMMARY OF THE INVENTION

The invention provides a data communication managing system including a first network segment client, a second network segment client and a center unit.

The first network segment client includes a plurality of first users. The first users communicate with each other. The second network segment client includes a plurality of second users. The second users communicate with each other.

The center unit can be imaged as a server with management function. The center unit includes a managing unit and a storing unit. The managing unit includes a user management part and a transmission management part.

The center unit communicates with the first network segment client and the second network segment client respectively and controlling the first network segment client and the second network segment client not to communicate with each other via the transmission management part of the managing unit.

Besides, the invention also provides a data communication managing method, and the steps are as follows:

Step a. Information of users' network segment is detected.

Step b. A first network segment client and a second network segment client are classified according to the information of users'.

Step c. A center unit communicates with the first network segment client and the second network segment client respectively and controls the first network segment client and the second network segment client not to communicate with each other.

The data communication managing system and method can improve the performance, since all communication is in the same network segment, not transmitting data across different network segments and further to efficiently decrease the transmission amount in network backbone.

These and other features, aspects and advantages of the disclosure will become better understood with regard to the following description, appended claims, and accompanying drawings.

### BRIEF DESCRIPTION OF THE DRAWINGS

FIG. 1 shows the schematic of conventional technology of P2P system.

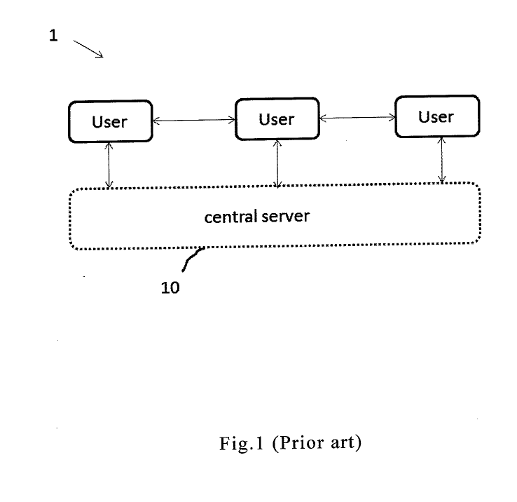

FIG. 2 shows a diagram of a data communication managing system in the invention.

FIG. 3 shows a diagram of an embodiment of a data communication managing system in the invention.

FIG. 4 shows a flowchart of a data communication managing method in the invention

### DETAILED DESCRIPTION OF THE INVENTION

For clarity of disclosure, and not by way of limitation, the detailed description of the invention is divided into the subsections that follow.

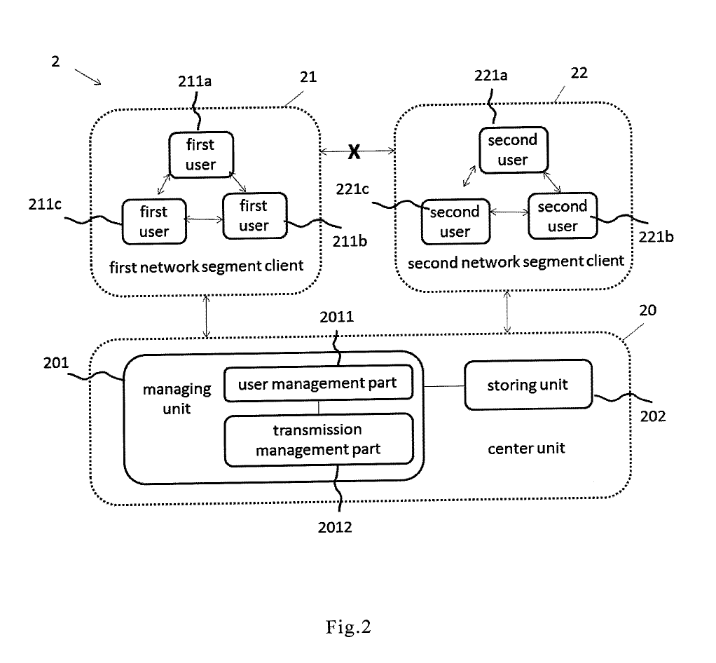

FIG. 2 is a diagram showing a data communication managing system in the invention. The data communication managing system 2 of the invention includes a first network segment client 21, a second network segment client 22 and a center unit 20.

The first network segment client 21 includes a plurality of first users. In an embodiment, three first users 211a, 211b, 211c are taken as an example, but not limited to. The three first users 211a, 211b, 211c are not only taken as clients, but also taken as servers. Therefore, the first users 211a, 211b, 211c can communicate with each other, such as downloading data or sharing data.

Besides, the first users respectively include a first verification code corresponding to the location of the first network segment client 21. For example, the IP address of the first network segment client 21 are 210.228.100.1˜254, but not limited to. If a user's IP address is 210.228.100.50, it is determined that the user belongs to the first network segment client 21.

The second network segment client 22 includes a plurality of second users. In an embodiment, three second users 221a, 221b, 221c are taken as an example, but not limited to. The three second users 221a, 2121b, 221c are not only taken as clients, but also taken as servers. Therefore, the second users 221a, 221b, 221c can communicate with each other, such as downloading data or sharing data.

The second users respectively include a second verification code corresponding to the location of the second network segment client 22.

The center unit 20 can be imaged as a server with management function. The center unit 20 includes a managing unit 201 and a storing unit 202. The managing unit 201 includes a user management part 2011 and a transmission management part 2012. The storing unit 202 is electrically connected to the managing unit 201, and is used to store lots of media data or any other data, but not limited to in the invention.

The user management part 2011 of the managing unit 201 is used to manage the data of the first network segment client 21 and the second network segment client 22. The data includes users' verification codes, IP addresses or information of limits of authority, but not limited to in the invention.

The transmission management part 2012 of the managing unit 201 is electrically connected to the user management part 2011, the transmission management part 2012 is used to control or match the data of the first network segment client 21 and the second network segment client 22.

The center unit 20 communicates with the first network segment client 21 and the second network segment client 22 respectively. The center unit 20 controls the first network segment client 21 and the second network segment client 22 not to communicate with each other via the transmission management part 2012 of the managing unit 201.

In other words, the center unit 20 can share data with the first network segment client 21 and the second network segment client 22, but the first network segment client 21 and the second network segment client 22 cannot share data with each other.

In an embodiment, three first users 211a, 211b, 211c are taken as an example, but not limited to. The three first users 211a, 211b, 211c are not only taken as clients, but also taken as servers to communicate with each other, such as downloading data or sharing data. Because the three first users 211a, 211b, 211c are located in the same network segment, there will be a better efficiency while communicating with each other. It can improve the performance, since the transmission management part 2012 controls or matches the data of the first network segment client 21 and the second network segment client 22 to avoid transmitting data across different network segments and further to efficiently decrease the transmission amount in network backbone.

As above embodiment stated, when the three first users 211a, 211b, 211c communicate with each other, they also report the status back to the center unit 20 at the same time. The status includes network breaking down, download completing, and etc., but not limited to.

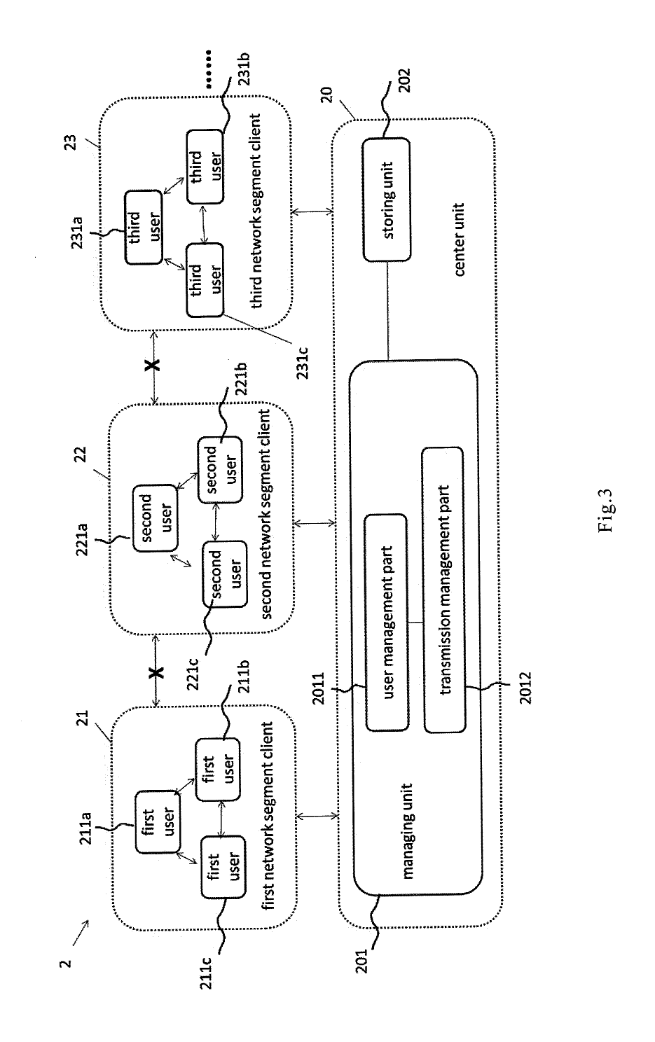

Besides, FIG. 3 is a diagram of an embodiment showing a data communication managing system in the invention. The data communication managing system of the invention is not only applied to the first network segment client 21 and the second network segment client 22, but also applied to more network segment clients, such as the third network segment client 23 with the third users 231a, 231b, 231c.

When a network segment client being as a server in the situation of not completing the communication, the center unit 20 will provide a new network segment client qualified for communicating until completing the requirement of communication. Taking the first users 211a as an example, when the first users 211b requires the first users 211a sharing data, but the network breaks down during the process of communication, the center unit 20 may provide the first users 211c as the new network segment client to complete the requirement of communication. It can improve the performance, since all communication is in the same network segment, not transmitting data across different network segments and further to efficiently decrease the transmission amount in network backbone.

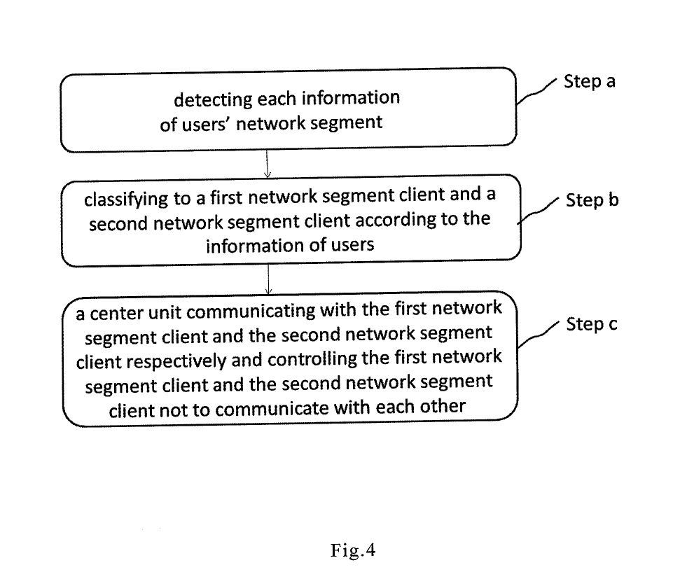

Besides, the invention also provides a data communication managing method. FIG. 4 is a flowchart showing a data communication managing method in the invention, and the steps are as follows:

Step a. Information of users' network segment is detected. The information of network segment can be taken as an identification code including the information of the users' location or other relative data, but not limited to in the invention.

Step b. A first network segment client and a second network segment client are classified according to the information of users'. For example, if three IP addresses of three users are respectively 210.228.100.50˜52, then the three users will be classified to the same network segment client, such as the first network segment client.

Step c. A center unit communicates with the first network segment client and the second network segment client respectively and controls the first network segment client and the second network segment client not to communicate with each other. The first network segment client includes a plurality of first users, and the first users communicate with each other. The second network segment client also includes a plurality of second users, and the second users communicate with each other. The center unit controls the first network segment client and the second network segment client not to communicate with each other via the transmission management part of the managing unit.

It can improve the performance, since all communication is in the same network segment, not transmitting data across different network segments and further to efficiently decrease the transmission amount in network backbone.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A data communication managing system, comprising:
a first network segment client, having a plurality of first users, the first users communicate with each other;
a second network segment client, having a plurality of second users, the second users communicate with each other; and
a center unit, having a managing unit, the center unit communicating with the first network segment client and the second network segment client respectively and controlling the first network segment client and the second network segment client not to communicate with each other via the managing unit.

2. The data communication managing system according to claim 1, wherein the center unit has a storing unit electrically connected to the managing unit.

3. The data communication managing system according to claim 1, wherein the first users respectively have a first verification code corresponding to the location of the first network segment client.

4. The data communication managing system according to claim 1, wherein the second users respectively have a second verification code corresponding to the location of the second network segment client.

5. The data communication managing system according to claim 1, wherein the managing unit has a user management part for managing the data of the first network segment client and the second network segment client.

6. The data communication managing system according to claim 5, wherein the managing unit has a transmission management part electrically connected to the user management part, the transmission management part is used to control or match the data of the first network segment client and the second network segment client.

7. A data communication managing method, comprising:
detecting each information of users' network segment;
classifying to a first network segment client and a second network segment client according to the information of users'; and
a center unit communicating with the first network segment client and the second network segment client respectively and controlling the first network segment client and the second network segment client not to communicate with each other.

8. The data communication managing method according to claim 7, wherein the information of users' network segment is corresponding to the locations of the users.

9. The data communication managing method according to claim 7, wherein the first network segment client has a plurality of first users, and the first users communicate with each other.

10. The data communication managing method according to claim 7, wherein the first network segment client has a plurality of second users, and the second users communicate with each other.

11. The data communication managing method according to claim 7, wherein the center unit has a transmission management part used to control or match the data of the first network segment client and the second network segment client.
